(19) United States
(12) Patent Application Publication
(10) Pub. No.: US 2009/0053114 A1
(43) Pub. Date: Feb. 26, 2009

(54) Reactor For The Treatment Of Highly Viscous Plastic Melts

(75) Inventors: Rudolph Kämpf, Gründau (DE); Michael Schulze, Frankfurt am Main (DE)

Correspondence Address: K.F. ROSS P.C., 5683 RIVERDALE AVENUE, SUITE 203 BOX 900, BRONX, NY, 10471-0900, US

(73) Assignee: LURGI ZIMMER GMBH, Frankfurt Am Main (DE)

(21) Appl. No.: 11/667,803

(22) PCT Filed: Oct. 20, 2005
(86) PCT No.: PCT/EP2005/011265

§ 371 Date: May 12, 2008

(30) Foreign Application Priority Data
Nov. 12, 2004 (DE) 10 2004 054 687.8

(51) Int. Cl. B01J 19/18

(52) U.S. Cl. 422/135

(57) ABSTRACT

The invention relates to a reactor for the treatment of highly viscous plastic melts, comprising a horizontal, cylindrical container (2) with a vapour exhaust and chambers in the region of the melting bath, formed by the arrangement of panel walls, in which annular discs, fixed to a shaft (3) by spokes and serving as stirrer elements (4, 5) may be rotated, whereby, in the cavities of the annular discs (4, 5), two opposing scrapers (6, 7) are fixed to the inside of the container at an offset angle and run past at a small separation from the front faces of the annular discs and the sleeve of the shaft (3). According to the invention, the assembly and disassembly of the shaft and scraper is simplified by connection of the scraper to the inside of the container by means of a positive connection (13, 19).

The invention relates to a reactor for processing highly viscous plastic melts consisting of a horizontally oriented cylindrical housing comprising a heatable double casing, sealed at both ends by a cover, with sheet metal walls arranged in the area of its melt sump, provided with penetrations and forming separate chambers, with a melt inlet on one housing side and a melt outlet, possibly with a spillway attached in front thereof, on the other, with a shaft mounted on the side of the cover, on which shaft, several rings are mounted spacedly and attached on spokes, acting as stirring elements, with a vapor outlet on the housing circumference or on the cover at the end of the melt outlet, and with a crescent-shaped clearance formed in an upper area of the housing between outer edges of the rings and an inner surface of the housing, two frame-shaped diametrally opposite strippers being attached stationarily in spaces between the rings to the inner surface of the housing and guided at an offset angle and at a small spacing from end faces of the rings and casing past the shaft. The invention relates especially to a device for producing polycondensates from condensates preformed by a melting process through polycondensation at increased temperatures and under vacuum.

When using the reactors described in, e.g. German patent DE-B-1745541 [U.S. Pat. No. 3,499,873], for the production of cross-linking degrading condensation polymers, it is known that small amounts of substance remain in the reactor for a longer period or permanently due to their high viscosity thereby compromise product quality as a result of cross-linking and/or discoloration. This problem can be mitigated by employing reactors with annular stirring rings. Such circular-ring reactors consist of a horizontal cylindrical housing with a double wall serving to heat and adjust the needed temperature in the reaction space. With a simple circular-ring reactor, precondensate enters the housing through a product inlet port in at a front end, and, depending on the processing stage, the prepolycondensate and/or polycondensate exits via a product outlet port at the downstream end of the housing. In the housing itself, annular stirring rings attached on spokes are rotatable mounted on a throughgoing, possibly heatable shaft, which may also be a hollow shaft. The circular rings placed individually or severally in combination according to the viscosity of the melt to be processed move in chambers situated in the lower segment containing the product sump, which chambers are separated by sheet metal plates preventing unmixed parts of the melt entering the housing from reaching the product outlet. The size of the chambers is adjusted according to the viscosity of the melt to be processed such that the spacing between partitions increases with increasing viscosity. The partitions, which may be heatable, are provided with specially designed penetrations allowing a targeted exchange of melt between the chambers. The evaporating fission products (vapors) are released through an outlet port at the downstream end of the housing or in its casing. Ensuring trouble-free release of the pre- or polycondensation product, as well as a sufficient dwell time and filling level of the melt requires a sufficient high and constant level of melt in the chamber from which the pre- or polycondensation product is released, which is why uniformly spaced rings are not provided in this chamber. The rings collect melt from the chambers filled with melt up to 50% of their radial height, lifting it on the ring surfaces. When the horizontal plane encompassing the axis of the shaft is exceeded, gravity acts on the melt so that the melt flowing down from the rings encounters the melt lifted by the rings, thereby creating an accumulation producing a vertical runoff and dripoff from the inside edge of the ring so that initial veils or films of melt are produced. When the viscosity of the melt and the circumferential velocity of the rings are in a certain relationship to one another, large-surfaced thin. films of melt form on top of the whole free ring surface areas flowing back into the melt sump, where they are remixed from below. Such circular-ring reactors are suitable for processing melts with viscosities of up to 300 Pa×s. When processing melts with greater viscosities and thermally sensitive polymers, degradation occurrences causing discoloration may occur where the rings meet the reactor wall, where the melt mixes insufficiently. To avoid this, shear elements are arranged between adjacent rings, which elements cleanse the rings and reactor walls, and redistribute and/or mix the melt from below. Beside high temperatures, vacuum is part of normal operating conditions. Keeping the loss of pressure via the reactor at a minimum requires a clearance functioning as a steam space above the rings in order to release the evaporating vapors. Creating this space is done by mounting the shaft eccentrically relative to the housing axis, and by the formation of the steam space between the external circumference of the ring and the inner surface of the housing with a spacing that is greater than at the bottom. Through this space, which is cross-sectionally crescent-shaped, the vapors flow unimpeded until reaching the outlet port. Product droplets carried along with the vapors (entrainment) are precipitated at the rings and then re-fed into the process.

According to German patent DE-A-3743051 [U.S. Pat. No. 5,055,273], a stationary stripper and an accumulation element are provided between every two adjacent rings and attached to the interior surface of the reactor. The accumulation elements are placed above the horizontal plane encompassing the axis of the shaft and have a spherical shape that expands in proximity of the shaft and whose shaft-side section interferes with the melt before its housing-side base. This gives rise to a displacement of the melt toward the outside, thereby preventing premature outflow of the melt into the interior of the housing, something which is undesirable in terms of complete melt impingement and housing wall self-cleaning. The melt accumulating at the accumulating elements undergoes shear by the rings and are extracted with a fresh surface in the circumferential direction. The melt transport and the regular distribution of melt via the housing wall are assumed by drag strips situated at the external circumference of the rings. Due to the frame-shaped, stripping elements moving along the edge and placed below the horizontal plane encompassing the axis of the shaft, the melt layers adhering to the shaft, the lateral surfaces of the ring and the inner surfaces of the drag strips undergo renewed shear and film formation, and the ring is cleaned before immersion of the rings into the melt sump. The rings may be heatable. These circular-ring reactors are successfully employed when producing highly viscous polymers in a non-discolored fashion with the conventional circular-ring reactor described above is no longer possible.

The disadvantage of these ring-ring reactors consists in the relatively high costs of assembly, and especially disassembly, since the shaft may only be withdrawn axially after destroying the welded connection between the stripper and the inner surface of the housing, or by using rings of a similar design, but separable into several sections. Welding the stripper together with the inner surface of the housing must be done with great precision and in conformance with the distance of the rings placed on the shaft. A later correction for distance is not possible with this embodiment.

The object of the present invention is to design the reactor described in the beginning such that simpler assembly and disassembly of the shaft and stripper becomes possible.

This object is achieved by attaching the strippers by means of a form-fit connection, e.g. a pin, bolt, or key connection, on the inner surface of the housing. Since the strippers are mounted on the immersion side, the melt layers adhering on the end faces of the rings are stripped and subjected to shearing. The strippers placed at the emersion side ensure that the thickness of the melt layer on the rings is limited to 30 to 75 mm, making it possible to produce thin films with a defined surface. This results in a uniform reaction time, a constant diffusion path and consequently, products that are more homogeneous.

The axial distance between the end faces of the stirring rings and the immediately opposing surfaces of the stripper element. is 1 to 20 mm, preferably 5 to 15 mm.

The design of the stripper elements is rectangular or trapezoidal, the longer of the parallel sides of the trapezoid being adjacent the shaft.

According to a special feature of the invention, the frame pieces positioned parallel to the stirring rings, and the sump-side edge of the frame piece positioned adjacent and parallel to the shaft are provided with a sharp edge on the sides facing away from the stirring rings and the shaft in order to obtain thorough separation of the melt.

As part of the inventive design, the frame pieces parallel to the stirring rings and the frame pieces of the stripping elements parallel and adjacent the shaft are tilted relative to a vertical plane extending perpendicular to the shaft or a vertical plane including the axis of the shaft. Shear is created when the frame pieces of the stripper elements form an acute angle with the stirring rings. With an obtuse angle of the frame pieces, shear and crush action of the melt may be achieved. With an acute-angle orientation of the frame pieces of the stripper elements, the sheared-off melt is carried back into melt sump by the frame, whereas with an obtuse-angle arrangement of the frame pieces of the stripper elements, the sheared-off/squashed melt exits from the bottom up through the frame opening and carried outside via the frame piece flows back into the melt sump.

In the direction toward the inside of the housing, the frame pieces of the strippers only removing the melt from the end faces of the rings and opposing the end faces of the rings protrude 5 to 20 mm above inside edges of the rings.

In order to ensure positioning of the stripper elements even under heavy loads, the diametrally opposite strippers get the required flexural strength by being mounted on a support plate extending perpendicular to the axis of the shaft, which plate is attached on the sump side on the inner surface of the housing by means of a quick connection. A part-circular seat of the support plate situated at the inner end at the shaft fits the section of the shaft facing the sump, thereby leaving a 0.5 to 5 mm gap between the shaft and seat. In this way, the support plate prevents melt adhering to the shaft from being moved along axially to the melt outlet passing through the sump.

A special embodiment of the invention is therefore to be seen in the fact that with a centrally mounted shaft, the radius of curvature of the rings sections extending between the spokes of the rings is greater than the radius of curvature of the inner surface of the housing.

According to a further feature of the invention, the centrally mounted shaft is movable in an oscillating fashion and/or axially slidable.

The invention is described in more detail below by way of examples. In the figures:

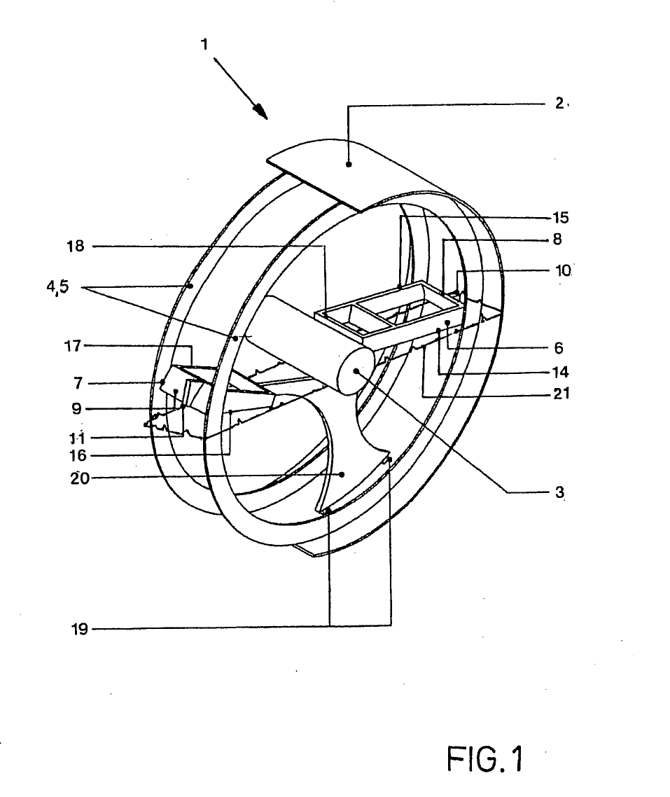

FIG. 1 is a perspective section through a reactor with rings between which are provided rectangular strippers;

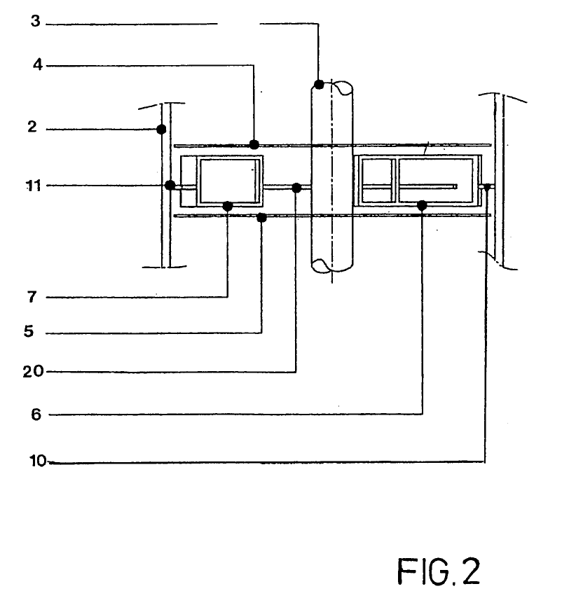

FIG. 2 is a cross-section through a portion of a reactor with rings with strippers situated therebetween and extending along a horizontal plane including the axis of the shaft;

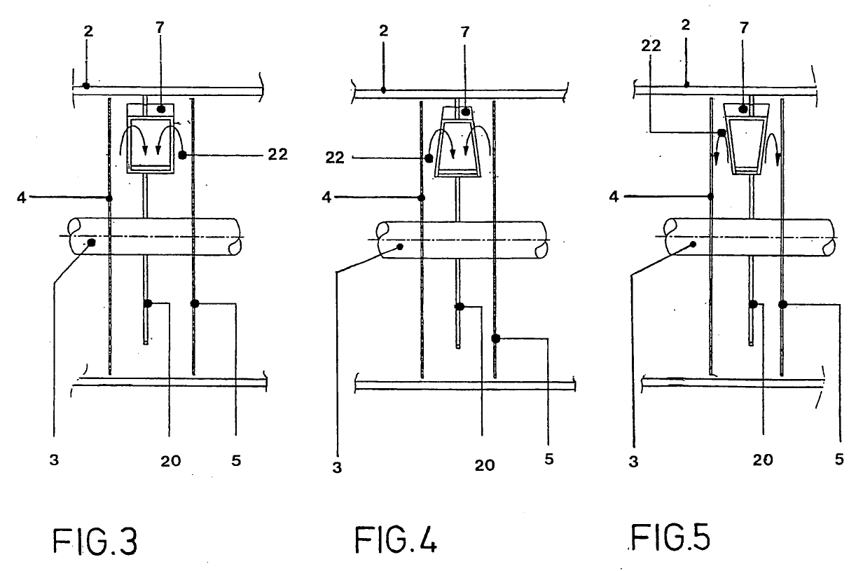

FIGS. 3-5 are each a cross-section through a portion of a reactor with rings with strippers of different cross-sectional shapes situated between the rings and extending along a horizontal plane including the axis of the shaft;

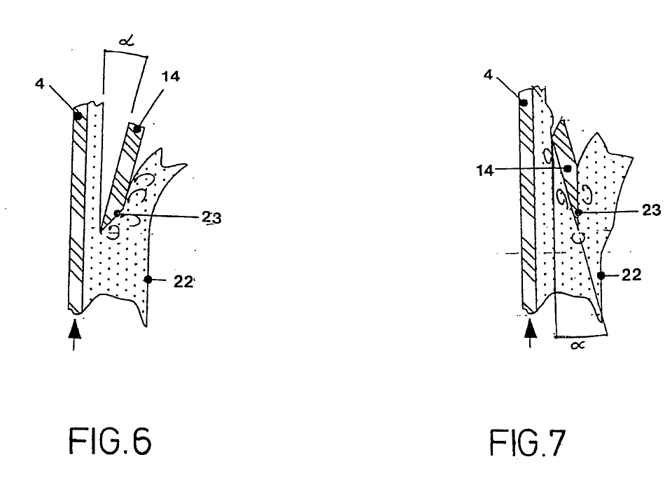

FIGS. 6 and 7 are each a schematic illustration of the operating principle of the frame piece of the stripper adjacent the rings and with different angles of inclination;

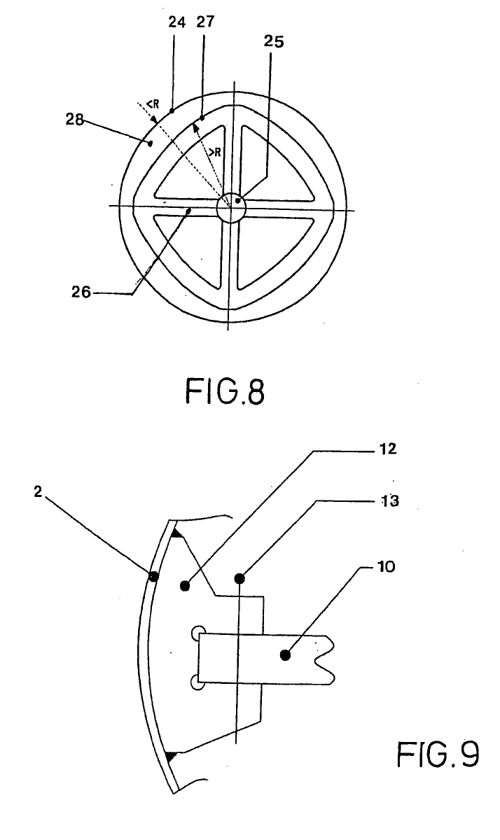

FIG. 8 is a front view of a noncircular ring with a curvature of the ring sections extending between the spokes that is greater than the curvature of the inside of the housing;

FIG. 9 is a detailed schematic illustration of a form-fit connection designed as a bolt connection between the inner surface of the housing and a stripper.

With melt viscosities >300 Pa×s and thermally highly sensitive polymers, avoiding occurrences of degradation and related discolorations requires intensive mixing of the melt. To achieve this, a horizontal housing (1) with a heatable double wall (2) and unillustrated flat covers on both its ends is employed as a reactor. In its interior, the reactor contains a heatable hollow shaft (3) eccentrically mounted on the end covers and to which stirring elements with rings (4 and 5) are attached by means of unillustrated spokes. The eccentric mounting of the hollow shaft (3) is necessary to create in the upper portion of the housing (1) a collection chamber for vapors formed during stirring, which vapors are vented via an unillustrated opening formed in the double wall (2). Between each pair of adjacent rings (4 and 6) are two opposite frame-shaped strippers (6 and 7) offset by 190°. The strippers (6 and 7) are secured to plates (12) welded to the inner face of the housing (1) by respective connector elements (10 and 11). The connectors (10 and 11) each have a hole through which a safety bolt (13) passes. Because of the unillustrated fork-shaped seat in the mounting plate (12), the connecting element (10 and 11) is easy to install after the shaft (3) is mounted. The frame side pieces (14, 15, 16, and 17) of the strippers (6 and 7) facing the end faces of the rings (4 and 5) are set at a small spacing of about 3 mm from the end faces of the rings (4 and 5). The frame piece (18) of the stripper (6) close to the hollow shaft (3) scrapes the melt from the hollow shaft (3) and displaces it axially, while the stripper (7) only removes melt from the rings (4 and 5). The bending and rotational forces acting on the strippers (6 and 7) are absorbed by hyperbolically shaped—when viewed in axial direction—support plates (20) extending perpendicular to the direction of flow of the melt and connected with the inner surface of the housing (2) via integral joints (19). At the end of each support plate (20) close to the hollow shaft (3), there is a part-circular seat in which the hollow shaft (3) rotates at a spacing of about 2.5 mm from the end of the support plate (20). The support plate (20) prevents melt on the hollow shaft (3) from being carried axially to the melt outlet without being fed through the melt sump (21). The strippers (6 and 7) clean the end faces of the rotating rings (4 and 5) and the outer surface of the hollow shaft (3), the melt adhering to the rings (4 and 5) and the hollow shaft (3) being subjected to shear and/or crush action depending on the shapes of frames of the strippers (6 and 7). Typically, the strippers (6 and 7), as shown in FIG. 3, have an open rectangular shape, or according to FIG. 4, an open trapezoidal shape, the longer of the parallel frame sides being juxtaposed the hollow shaft (3). FIG. 5 shows a trapezoidal frame shape with the longer of the parallel frame sides being juxtaposed with the inner surface of the housing (1).

As shown in FIG. 6, the frame pieces (14, 15, 16, and 17) of the strippers (6 and 7) juxtaposed with the end faces of the rings (4 and 5) form an acute angle α of 20° from above, or from below with the end faces of the rings (4 and 5) as shown in FIG. 7. The frame pieces (14, [15], 16, and [17]) according to FIG. 6 are inclined as seen from above at an acute angle to the end faces of the rings (4, [5]) so as to substantially subject the melt layer (20) adhering to the rings (4 and [5]) to shear prior to reimmersion into the melt sump (8), while the frame pieces (14, [15], 16, and [17]), according to FIG. 7, are inclined as seen from below at an acute angle to the end faces of the rings (4 and [5]) so as to create shear and crush stress in the melt layer (22) adhering to the rings (4 and [5]). The melt is carried back into the melt sump (8) by the frames of the strippers (6 and 7). The inclination of the frame pieces (14, [15], 16, and [17]) at an acute angle in combination with a knife-like sharpening (23) on the edge of the frame pieces facing away from the end face of the rings (4 and [5]) ensures easy and gentle separation of the melt layer (22).

In the cross-section of a housing (24) serving as a reactor, schematically represented in FIG. 8, a noncircular ring (27) is connected to the centrally mounted shaft (25) via spokes (26), the ring sections extending between the spokes (26) having a radius of curvature (<R) exceeding that of the inner surface of the housing (24) (>R) so that a crescent-shaped clearance (28) is created in the upper area of the housing (24) through which vapors may escape in a preferred way. The crescent-shaped clearance (28) follows in an advantageous way the rotation of the ring (27) and thus contributes to cleaning of the inner surface of the housing (24). Periodic axial displacement of the shaft (25) results in an especially favorable removal of deposits from the inner surface of the housing (24).

The form-fit connection schematically shown in FIG. 9 allows a clearly simplified replacement of the rings and/or the shaft during maintenance or repair of the reactor, since the insertable and detachably fastened stripper may be removed without any great difficulty.

1-12. (canceled)

13. A reactor for processing a highly viscous plastic melt, the reactor comprising:
a generally cylindrical housing centered on a horizontal axis and having a side wall extending axially between an inlet end and an outlet end, whereby melt is flowed through the housing axially from the inlet end to the outlet end;
a shaft extending axially through the housing;
a plurality of axially spaced rings fixed to the shaft and having axially directed end faces defining in the housing a succession of axially spaced chambers and having outer edges spaced below an inner surface of the housing at an upper region of the housing, whereby rotation of the shaft rotates the rings an mixes the melt that flows from chamber to chamber through the rings and vapors generated from the melt can collect in the upper region of the housing and pass axially between the rings and the housing in the upper region for removal from the housing;
a respective pair of generally diametrally opposite strippers in each of the chamber each having an open frame and having radially extending side pieces juxtaposed the respective end faces; and
respective releasable form-fit connections between each of the strippers and the inner surface of the housing side wall and fixedly mounting the strippers in the housing, whereby melt adhering to the rings is scraped off as the rings orbit past the strippers.

14. The reactor defined in claim 13 wherein the form-fit connections each have a part fixed to the housing inner surface and a pin or bolt releasably fitted between the respective part and the respective scraper.

15. The reactor defined in claim 13 wherein the open frames of the strippers are rectangular.

16. The reactor defined in claim 13 wherein the open frames of the strippers are trapezoidal and have axially extending short and long side pieces extending between the radially extending side pieces.

17. The reactor defined in claim 16 wherein the long side pieces are juxtaposed with the housing inner surface and the short side pieces are juxtaposed with an outer surface of the shaft.

18. The reactor defined in claim 16 wherein the short side pieces are juxtaposed with the housing inner surface and the long side pieces are juxtaposed with an outer surface of the shaft.

19. The reactor defined in claim 13 wherein the side pieces have sharp edges juxtaposed closely with the respective end faces.

20. The reactor defined in claim 19 wherein the side pieces extend at acute angles to the respective end faces.

21. The reactor defined in claim 13, further comprising
respective support plates below the shaft in the housing, extending generally perpendicular to the axis, and each having an inner end juxtaposed with the shaft and an outer end permanently and integrally fixed to the housing inner surface.

22. The reactor defined in claim 13 wherein each open-frame side piece is spaced axially between 1 mm and 20 mm from the respective end face.

23. The reactor defined in claim 13 wherein the open frames each have radially inner and outer axially extending side piece spaced radially apart and bridging the respective radially extending side pieces, the inner side pieces being spaced radially between 1 mm and 20 mm from an outer surface of the shaft.

24. The reactor defined in claim 13 wherein the rings have inner peripheries and the side pieces extend radially inward between 50 mm and 200 mm past the respective inner peripheries.

25. The reactor defined in claim 13 wherein the shaft is offset from but parallel to the housing axis.

26. The reactor defined in claim 13 wherein the shaft is substantially centered on the housing axis and is provided with radially extending spokes fixed to the rings and subdividing the rings into a plurality of segments, each segment having an outer edge with a greater radius of curvature than an inner radius of curvature than the housing inner surface.

27. The reactor defined in claim 13, further comprising
means for axially reciprocating the shaft and rings.
